(19) United States
(12) Patent Application Publication
(10) Pub. No.: US 2013/0131913 A1
(43) Pub. Date: May 23, 2013

(54) METHOD AND SYSTEM FOR MANAGING OIL LEVEL FOR VEHICLE

(71) Applicants: Min Gyun Chae, Hwaseong-si (KR); Jong Kil Lim, Hwaseong-si (KR); Hong Woon Jang, Ansan-si (KR); Jae Pil Lim, Hwaseong-si (KR)

(72) Inventors: Min Gyun Chae, Hwaseong-si (KR); Jong Kil Lim, Hwaseong-si (KR); Hong Woon Jang, Ansan-si (KR); Jae Pil Lim, Hwaseong-si (KR)

(73) Assignees: Kia Motors Corp., Seoul (KR); Hyundai Motor Company, Seoul (KR)

(21) Appl. No.: 13/487,841

(22) Filed: Jun. 4, 2012

(30) Foreign Application Priority Data
Nov. 22, 2011 (KR) 10-2011-0122083

(51) Int. Cl. G01M 15/04

(52) U.S. Cl. 701/29.5

(57) ABSTRACT

A method for managing an oil level for a vehicle includes a key-on process of judging whether the vehicle is in a key-on state or more, a preparation process of judging whether the temperature of engine oil of the vehicle and an engine rpm are within predetermined ranges, a comparison process of comparing the level of the engine oil with a level table additionally provided by continuously measuring the level of the engine oil for a predetermined time when the engine oil is within the predetermined range, and a warning process of giving warning when the level of the engine oil is larger than the value of the level table as a result of the comparison, and a system for managing an oil level for a vehicle.

### CROSS-REFERENCE TO RELATED APPLICATION

The present application claims priority of Korean Patent Application Number 10-2011-0122083 filed Nov. 22, 2011, the entire contents of which application is incorporated herein for all purposes by this reference.

### BACKGROUND OF INVENTION

1. Field of Invention

The present invention relates to a method and a system for managing an oil level for a vehicle that warns excessive injection of engine oil when engine oil is excessively injected by mistake at an initial stage.

2. Description of Related Art

Engine oil should maintain an appropriate level in a driving system of a vehicle. An engine deteriorates when the engine oil is short and abnormal combustion of the engine is caused when the engine oil is excessive.

A measurement method using ultrasonic waves has been generally used in order to measure the oil level and the ultrasonic measurement method has advantages that reaction is rapid and accurate as compared with a hot-wire method, wrong diagnosis is prevented, and fluctuation of an oil surface while driving can be recognized.

Meanwhile, a basic control logic in an engine oil level sensor in the related art is compared with a reference map by averaging driving accumulation for a predetermined distance or a predetermined time (EX: 100 km or 1 hour), and as a result, when the oil level in the basic control logic is lower than that of the reference map, “short warning” is configured and when the oil level is higher, “excessive warning” is configured.

However, in the system, in the case where the oil is excessively injected due to a mistake of an operator when the engine oil is injected at an initial stage or when the engine oil is replaced for repairing, the engine oil is instantaneously introduced into a suction system at an initial start stage, such that a case in which “dieseling” occurs cannot be checked.

That is, in the related art, a warning lamp is controlled after a mileage is accumulated for a predetermined time, such that warning cannot be given at initial injection.

In addition, the oil is introduced into the suction system in the meanwhile, and as a result, abnormal combustion occurs due to the dieseling.

Therefore, the measurement and warning processes of the level of the engine oil are separately controlled at the initial oil injection, however, the measurement and warning processes are configured together with the control the related art, and as a result, maintenance of the oil level which is more stable needs to be assisted.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a method and a system for managing an oil level for a vehicle that can sense the oil level in real time in a static state to control a warning lamp immediately without accumulation average of driving with a predetermined distance when oil is excessively injected by a mistake of an operator.

Various aspects of the present invention provide for a method for managing an oil level for a vehicle, including a key-on process of judging whether the vehicle is in a key-on state or more, a preparation process of judging whether the temperature of engine oil of the vehicle and an engine rpm are within predetermined ranges, a comparison process of comparing the level of the engine oil with a level table additionally provided by continuously measuring the level of the engine oil for a predetermined time when the engine oil is within the predetermined range, and a warning process of giving warning when the level of the engine oil is larger than the value of the level table as a result of the comparison.

In the preparation process, it may be judged whether the engine rpm is 0 and in the comparison process, when the engine rpm is 0, the level of the engine oil may be measured.

The predetermined ranges of the temperature of the engine oil and the engine rpm in the preparation process may be set to 110° C. and 2800 rpm.

The level table in the comparison process may be a map prepared with the appropriate level of the engine oil depending on the engine temperature and the rpm.

The warning process may further include a management process of measuring and averaging the level of the engine oil to compare the average value with the level table for the predetermined time or the predetermined driving distance when the level of the engine oil is not larger than the value of the level table as a result of the comparison giving warning when the average value is smaller than the value of the level table as a result of the comparison.

In the management process, excessive warning may be given when the average value is equal to or larger than the value of the level table by the predetermined range as the result of the comparison and short warning may be given when the average value is smaller than the value of the level table.

In the preparation process, it may be judged whether the engine rpm is 0, in the comparison process, the level of the engine oil may be measured when the engine rpm is 0 and the level table may have as a first map an appropriate oil level corresponding to the case where the engine rpm is 0 and as a second map an appropriate oil level corresponding to the case where the engine rpm more than 0, and in the warning process, the measured level value maybe compared with the first map and in the management process, the measured average value may be compared with the second map.

In the warning process, when the level of the engine oil is larger than the value of the level table by the predetermined range or more, excessive warning may be given and when the level of the engine oil is smaller than the value of the level table, short warning may be given as the comparison result.

Various aspects of the present invention provide for a system for managing an oil level, which is used to perform the management method, including a sensor unit measuring a key-on signal, the temperature of engine oil, the level of the engine oil, and an engine rpm, and a control unit including a level table prepared with a level value of the engine oil which is appropriate depending on the temperature and the rpm of the engine and continuously measures the level of the engine oil for a predetermined time to be compared with the level table if the temperature of the engine oil and the engine rpm are within predetermined ranges when the vehicle is in a key-on state or more and outputs a warning signal when the value of the level table is larger than the level of the engine oil as the comparison result.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart of an exemplary method for managing an oil level for a vehicle according to the present invention.

FIG. 2 is a comprehensive block diagram of an exemplary method for managing an oil level for a vehicle according to the present invention.

FIG. 3 is a diagram showing an example of a level table in an exemplary method for managing an oil level for a vehicle according to the present invention.

FIG. 4 is a configuration diagram of an exemplary system for managing an oil level for a vehicle according to the present invention.

It should be understood that the appended drawings are not necessarily to scale, presenting a somewhat simplified representation of various features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

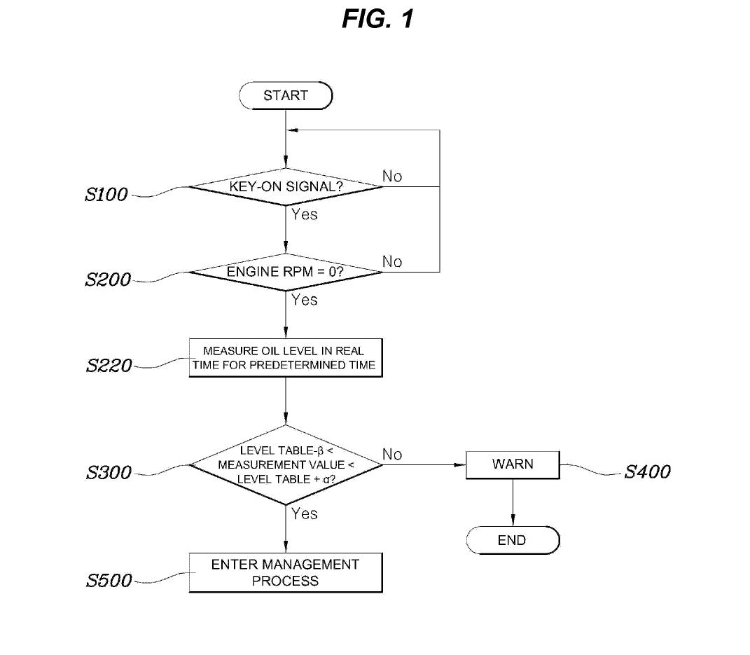

FIG. 1 is a flowchart of a method for managing an oil level for a vehicle according to various embodiments of the present invention. The method for managing an oil level for a vehicle according to various embodiments of the present invention includes a key-on process (S100) of judging whether the vehicle is in a key-on state or more, a preparation process (S200) of judging whether the temperature of engine oil of the vehicle and an engine rpm are within predetermined ranges, a comparison process (S300) of comparing the level of the engine oil with a level table additionally provided by continuously measuring the level of the engine oil for a predetermined time when the engine oil is within the predetermined range, and a warning process (S400) of giving warning when the level of the engine oil is larger than the value of the level table as a result of the comparison.

The method for managing an oil level for a vehicle according to various embodiments of the present invention is used to catch excessive refueling initially after the operator fill oil and to this end, it is first judged whether the vehicle is in the key-on state or more. That is, by measuring the oil level at the initial stage when a key is initially inserted, it is not required to ensure the predetermined driving distance in the related art. In addition, by the measuring the oil level at the initial stage, a dieseling phenomenon in starting caused by the excessive level can be prevented.

When it is determined that the vehicle is in the key-on or more, it is judged whether the temperature of the engine oil of the vehicle and the engine rpm are within the predetermined ranges. Herein, in various embodiments, in the preparation process (S200), it is judged whether the engine rpm is 0 and in the comparison process (S300), when the engine rpm is 0, the level of the engine oil is measured.

Since one goal of the present invention is to discover the state in which the level is in the excessive state at the initial start stage after oil is injected, it may be determined whether the level is excessive by measuring the level at 0 rpm before the engine starts.

Meanwhile, a driver may start the engine immediately after injecting the oil, and as a result, in order to provide against the case, the predetermined ranges of the temperature of the engine oil and the engine rpm in the preparation process (S200) are set to 110° C. and 2800 rpm to judge whether the level is excessive by measuring the level in the set section or less.

Thereafter, when the engine oil is within the predetermined range, the comparison process (S300) of comparing the level of the engine oil with the additionally provided level table by continuously measuring the level of the engine oil for the predetermined time and the warning process (S400) of giving warning when the level of the engine oil larger than the value of the level table as the comparison result are performed.

In the comparison process, the level of the engine oil is measured in real time and is compared with the value of the level table. Herein, the level table is a map prepared with the appropriate level of the engine oil depending on the engine temperature and the rpm.

In this regard, as shown in FIG. 3, at an initial level checking process, when the rpm is 0 the appropriate values of the oil level are provided depending on the temperature and an additional map is provided when the rpm is 0 or more to measure the level of the engine oil at a predetermined cycle depending on the driving distance. It will be described below.

In the comparison process, the level of the engine oil is measured at 0 rpm and compared with the appropriate value corresponding thereto to previously provide against the dieseling which may occur by warning excessive oil when the measurement value is larger than the value of the table.

Therefore, an operator or a consumer can prevent the dieseling by determining whether the oil is appropriated supplied before starting the engine after filling the oil.

Meanwhile, the warning process (S400) may further include a management process (S500) of measuring and averaging the level of the engine oil to compare the average value with the level table for the predetermined time or the predetermined driving distance when the level of the engine oil is not larger than the value of the level table as a result of the comparison giving warning when the average value is smaller than the value of the level table as the comparison result.

The management process described herein means an oil level management process during a general driving process by deviating the initial level measurement process and if there is no problem in the level of the engine oil as a result of the initial comparison result, the level of the oil is managed during general driving.

To this end, the level of the engine oil is measured and averaged for the predetermined time or the predetermined driving distance and compared with the level table and when the average value is smaller than the value of the level table as a result of the comparison to allow the driver to refill or replace the engine oil by giving warning. The reason for using the accumulation method is that the oil level is accurately checked as usual by average through the accumulation because a deviation in the level of the oil is significant.

However, as described above, since the level of the oil is influenced by only the temperature in the initial state after the oil is filled, it is desirable that the excessive refilling of the oil is discovered through real-time comparison with not the average value but the appropriate value depending on the corresponding temperature.

Meanwhile, in the management process (S500), excessive warning is given when the average value is equal to or larger than the value of the level table by the predetermined range as the comparison result and short warning is given when the average value is smaller than the value of the level table.

Further, in the preparation process (S200), it is judged whether the engine rpm is 0, in the comparison process (S300), the level of the engine oil is measured when the engine rpm is 0 and the level table has as a first map an appropriate oil level corresponding to the case where the engine rpm is 0 and as a second map an appropriate oil level corresponding to the case where the engine rpm more than 0, and in the warning process (S400), the measured level value may be compared with the first map and in the management process, the measured average value may be compared with the second map.

That is, as in the level table shown in FIG. 3, when the rpm is 0, only the oil level depending on the temperature is provided and the oil level is compared to give warning in the warning process and when the oil level is checked every predetermined driving distance after starting the engine, the average value is compared, and as a result, the oil level is accumulated and averaged to be compared with the second map of the level table. Further, in the warning process (S400), when the level of the engine oil is larger than the value of the level table by the predetermined range or more, excessive warning may be given and when the level of the engine oil is smaller than the value of the level table, short warning may be given as the comparison result.

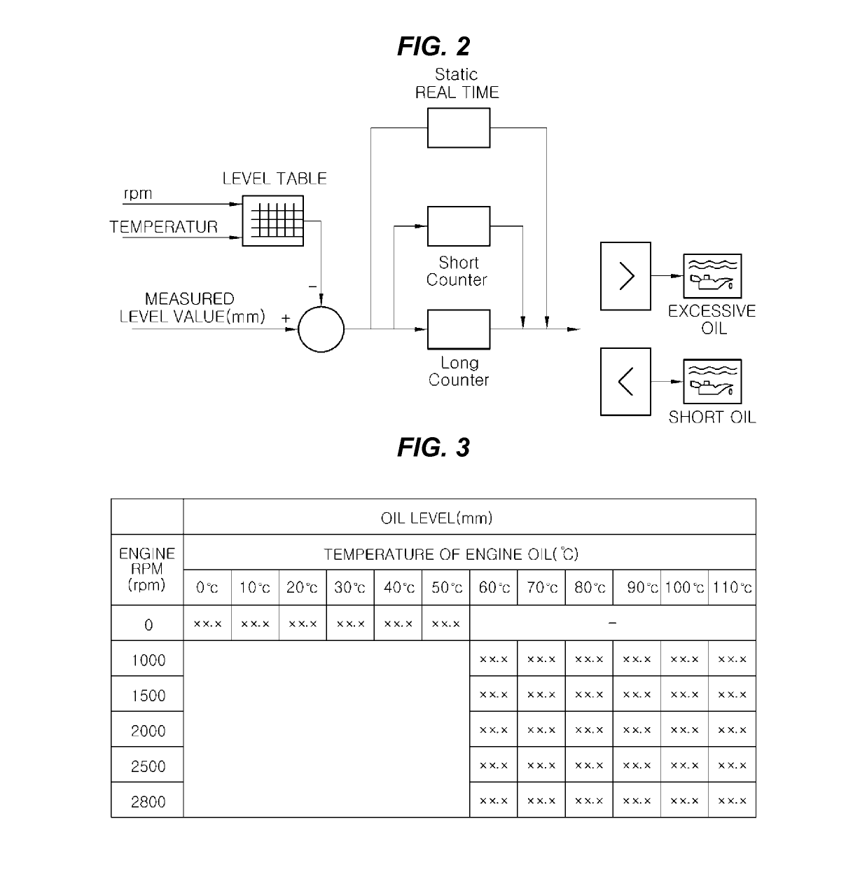

As the initial level checking process of the present invention, the warning process and the management process may be performed together and will be described with reference to FIG. 2.

FIG. 2 is a comprehensive block diagram of the method for managing an oil level for a vehicle according to various embodiments of the present invention. In the initial key-on state of the vehicle, the oil level is checked in real time to be compared with the level table. Therefore, the excessive refueling or the short refueling is judged.

Further, apart from the judgment process, the level of the engine oil is accumulated and averaged for the predetermined driving distance or the predetermined time after the engine is started and the oil temperature and the rpm are also averaged to be compared with the corresponding values of the level table to give the short or excessive warning of the oil.

Therefore, the excessive oil or the short oil is measured to be warned according to each situation even at initial refueling and middle refueling. In particular, the level of the oil is judged after long-terms driving by using a long counter during driving and if the short oil or the excessive oil is judged herein, continuous warning is given to the driver in a comparative short cycle by judging the level of the oil by using a short counter.

If the driver fills, discharge, or replace the oil in the case, whether the oil is appropriate can be known immediately after filling the oil by using a static scheme of checking the level of the oil in real time when the level of newly filled oil is not appropriate even though the warning depending on the long counter or the short counter is cancelled.

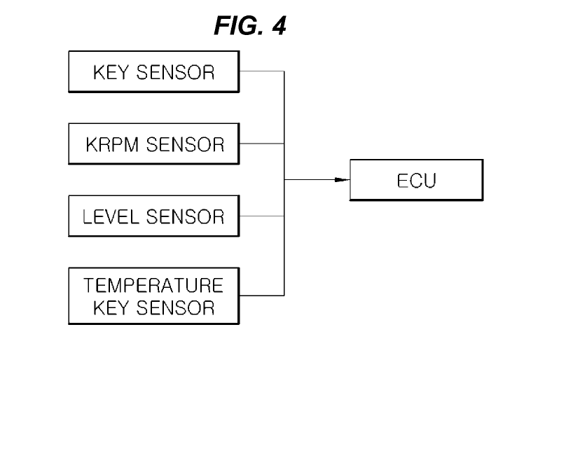

Meanwhile, FIG. 4 is a configuration diagram of a system for managing an oil level for a vehicle according to various embodiments of the present invention. The system for managing an oil level, which is used to perform the management method includes a sensor unit measuring a key-on signal, the temperature of engine oil, the level of the engine oil, and an engine rpm and a control unit including a level table prepared with a level value of the engine oil which is appropriate depending on the temperature and the rpm of the engine and continuously measures the level of the engine oil for a predetermined time to be compared with the level table if the temperature of the engine oil and the engine rpm are within predetermined ranges when the vehicle is in a key-on state or more and outputs a warning signal when the value of the level table is larger than the level of the engine oil as the comparison result.

The control unit is included in an ECU serving to control the engine to be performed and to this end, the ECU receives the level and the temperature value of the oil from various sensors and receives the rpm of the engine and even a key sensor may receive information in order to know the key-on state. The sensor unit is a concept including a direct sensor capable of providing various information or all other controllers capable of sharing the information and providing shared information through CAN communication.

According to a method and a system for managing an oil level for a vehicle having the above structure, the oil level can be in real time sensed in a static state to control a warning lamp immediately without accumulation average of driving with a predetermined distance when oil is excessively injected by a mistake of an operator. As a result, “dieseling” is prevented, which occurs when an engine starts after engine oil is excessively injected.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for managing an engine oil level for a vehicle, comprising:
a key-on process of judging whether the vehicle is in a key-on state;
a preparation process of judging whether a temperature of engine oil of the vehicle and an engine rpm are within predetermined ranges;
a comparison process of comparing a level of engine oil with a level table additionally provided by continuously measuring the level of the engine oil for a predetermined time when the engine oil is within the predetermined range; and
a warning process of giving warning when the level of the engine oil is higher than the value of the level table as a result of the comparison.

2. The method for managing an oil level for a vehicle of claim 1, wherein in the preparation process, it is judged whether the engine rpm is 0 and in the comparison process, when the engine rpm is 0, the level of the engine oil is measured.

3. The method for managing an oil level for a vehicle of claim 1, wherein the predetermined ranges of the temperature of the engine oil and the engine rpm in the preparation process are set to 110° C. and 2800 rpm, respectively.

4. The method for managing an oil level for a vehicle of claim 1, wherein the level table in the comparison process is a map prepared with the appropriate level of the engine oil depending on the engine temperature and the rpm.

5. The method for managing an oil level for a vehicle of claim 1, wherein the warning process further includes a management process of measuring and averaging the level of the engine oil to compare the average value with the level table for the predetermined time or the predetermined driving distance when the level of the engine oil is not larger than the value of the level table as a result of the comparison giving warning when the average value is smaller than the value of the level table as a result of the comparison.

6. The method for managing an oil level for a vehicle of claim 5, wherein in the management process, excessive warning is given when the average value is equal to or larger than the value of the level table by the predetermined range as the comparison result and short warning is given when the average value is smaller than the value of the level table.

7. The method for managing an oil level for a vehicle of claim 5, wherein in the preparation process, it is judged whether the engine rpm is 0, in the comparison process, the level of the engine oil is measured when the engine rpm is 0 and the level table has as a first map an appropriate oil level corresponding to the case where the engine rpm is 0 and as a second map an appropriate oil level corresponding to the case where the engine rpm more than 0, and in the warning process, the measured level value is compared with the first map and in the management process, the measured average value is compared with the second map.

8. The method for managing an oil level for a vehicle of claim 1, wherein in the warning process, when the level of the engine oil is larger than the value of the level table by the predetermined range or more, excessive warning is given and when the level of the engine oil is smaller than the value of the level table, short warning is given as the comparison result.

9. A system for managing an engine oil level for a vehicle, comprising:
a sensor unit measuring a key-on signal, a temperature of engine oil, a level of the engine oil, and an engine rpm; and
a control unit including a level table prepared with a level value of the engine oil which is appropriate depending on the temperature and the rpm of the engine and continuously measures the level of the engine oil for a predetermined time to be compared with the level table if the temperature of the engine oil and the engine rpm are within predetermined ranges when the vehicle is in a key-on state or more and outputs a warning signal when the value of the level table is larger than the level of the engine oil as the comparison result.
